(19) United States
(12) Patent Application Publication
(10) Pub. No.: US 2025/0266550 A1
(43) Pub. Date: Aug. 21, 2025

(54) POWER STORAGE DEVICE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Ashigarakami-gun (JP); Takahiko NAKANO, Nagoya-shi (JP); Toshihiro SHIMONAKA, Toyota-shi (JP); Kenichi KOHASHI, Sunto-gun (JP); Yuki SODA, Nagoya-shi (JP)

(73) Assignee: TOYOTA JIDOSHA KABUSHIKI KAISHA, Toyota-shi (JP)

(21) Appl. No.: 19/008,832

(22) Filed: Jan. 3, 2025

(30) Foreign Application Priority Data
Feb. 19, 2024 (JP) 2024-022907

(51) Int. Cl. H01M 50/242; B60L 50/64; H01M 50/209; H01M 50/258; H01M 50/289; H01M 50/548

(52) U.S. Cl. CPC H01M 50/242; H01M 50/209; H01M 50/258; H01M 50/289; H01M 50/548; B60L 50/64; H01M 2220/20

(57) ABSTRACT

A power storage device includes power storage modules that charge and discharge electric power, a power storage device case that accommodates the power storage modules, and a protective plate disposed outside a lower surface of the power storage device case. The protective plate includes a connection portion connected to the power storage device case. The connection portion is higher in at least one of rigidity and strength than a portion of the protective plate which is located around the connection portion. This can suppress an input of an external force, applied to the protective plate, to the power storage device case that accommodates the power storage modules more than when the portion of the protective plate which is located around the connection portion is connected to the power storage device case. An input of the external force from the protective plate to the power storage modules can be suppressed.

### CROSS REFERENCE TO RELATED APPLICATIONS

This nonprovisional application is based on Japanese Patent Application No. 2024-022907 filed on Feb. 19, 2024 with the Japan Patent Office, the entire contents of which are hereby incorporated by reference.

### BACKGROUND

### Field

The present disclosure relates to a power storage device.

### Description of the Background Art

In a conventional elongated secondary-battery power storage module, a plurality of laminate-type battery cells, each having electrodes at the opposite ends in the longitudinal direction, are sealed in an elongated case while being connected in series in the longitudinal direction. For example, in Japanese National Patent Publication No. 2023-502698, a plurality of battery cells are connected to each other in series with a laminated film removed. A battery pack including a stack of such elongated power storage modules in the transverse direction is disclosed in, for example, FIG. 18 of Japanese National Patent Publication No. 2023-502698.

### SUMMARY

In such an elongated power storage module, the case deforms more than a power storage module, which is not elongated, by the action of an external force caused by vibrations or the like. It is thus necessary to suppress an input of the external force to the power storage module via an accommodation case from a protective plate disposed outside the lower surface of the accommodation case.

The present disclosure has been made to solve the problem described above. An object of the present disclosure is to provide a power storage device that can suppress an input of an external force from a protective plate to a power storage module.

A power storage device according to the present disclosure includes a plurality of power storage modules that charge and discharge electric power, an accommodation case that accommodates the plurality of power storage modules, and a protective plate disposed outside a lower surface of the accommodation case. The protective plate includes a connection portion connected to the accommodation case. The connection portion is higher in at least one of rigidity and strength than a portion of the protective plate, the portion being located around the connection portion.

With such a configuration, the connection portion of the protective plate, which is higher in at least one of rigidity and strength than the portion of the protective plate located around the connection portion, is connected to the accommodation case that accommodates the power storage modules. This can suppress an input of the external force, applied to the protective plate, to the accommodation case that accommodates the power storage modules more than when the portion of the protective plate which is located around the connection portion is connected to the accommodation case. As a result, a power storage device can be provided that can suppress an input of an external force from the protective plate to the power storage modules.

The accommodation case may include a fixing portion connected to the connection portion of the protective plate. Each of the plurality of power storage modules may be fixed to a portion of an inner surface of the accommodation case, the portion being located above the fixing portion.

With such a configuration, the fixing portion of the accommodation case is connected to the connection portion of the protective plate which is higher in at least one of rigidity and strength than the portion of the protective plate which is located around the connection portion. This can suppress an input of the external force, applied to the protective plate, to the fixing portion of the accommodation case that accommodates the power storage modules more than when the accommodation case is connected to the portion of the protective plate which is located around the connection portion. As a result, an input of the external force from the protective plate to the power storage modules can be suppressed.

The power storage device may further include an adhesive that bonds each of the plurality of power storage modules to the accommodation case. The adhesive may be provided at a portion of the inner surface of the accommodation case, the portion being located above the fixing portion.

With such a configuration, the power storage modules are bonded to the portion located above the fixing portion with the adhesive. As a result, the power storage modules can be fixed more firmly to the robust portion of the accommodation case than when the power storage modules are bonded to the portion of the accommodation case which is different from the portion located above the fixing portion.

Each of the plurality of power storage modules may include a plurality of power storage cells including a first power storage cell and a second power storage cell arranged in one direction, a coupling portion, and a module case that accommodates the plurality of power storage cells and the coupling portion. The first power storage cell may include a first end adjacent to the second power storage cell, and a first terminal provided at the first end. The second power storage cell may include a second end adjacent to the first power storage cell, and a second terminal provided at the second end. The coupling portion may be formed by connection of the first terminal and the second terminal. Each of the plurality of the power storage modules may be fixed to the accommodation case in a portion of an outer surface of the module case, the portion being located outside the coupling portion.

With such a configuration, the power storage modules are fixed to the accommodation case in the portion, located outside the coupling portion, of the outer surface of the module case for the power storage modules at which the first terminal of the first power storage cell is connected to the second terminal of the second power storage cell. As a result, the coupling portion can be effectively fixed to the accommodation case.

The module case may include a top plate and a bottom plate arranged in an upward-downward direction. Each of the plurality of power storage modules may include a partition member provided in the module case and provided at the coupling portion. The partition member may be disposed across the top plate and the bottom plate.

With such a configuration, the coupling portion of the power storage module which is fixed to the accommodation case can be made robust by the partition member.

The protective plate may include a body portion shaped into a plate, and a rib formed to protrude upward from the body portion. The connection portion may be the rib.

Thus, the connection portion of the protective plate which is connected to the power storage device case can be made robust. Also, the protective plate itself can be made robust.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view showing a general shape of a vehicle according to an embodiment of the present disclosure.

FIG. 2 is a perspective view showing an outline of a configuration of a power storage device mounted in the vehicle according to the present embodiment.

FIG. 3 is a perspective view showing a general shape of a power storage module included in the power storage device of the present embodiment.

FIG. 4 is an exploded perspective view of the power storage module of the present embodiment.

FIG. 5 is an exploded perspective view of a power storage cell included in the power storage module of the present embodiment.

FIG. 6 is a sectional view of the power storage device of the present embodiment, which is taken along the A-A cross section.

FIG. 7 is a sectional view of the power storage module of the present embodiment, which is taken along the B-B cross section.

### DESCRIPTION OF THE PREFERRED EMBODIMENTS

Embodiments of the present disclosure will be described with reference to the drawings. In the drawings referred to below, the same or corresponding portions in the drawings are denoted by the same reference characters.

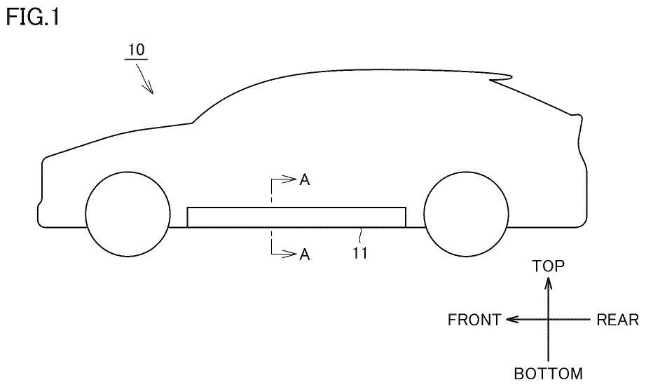

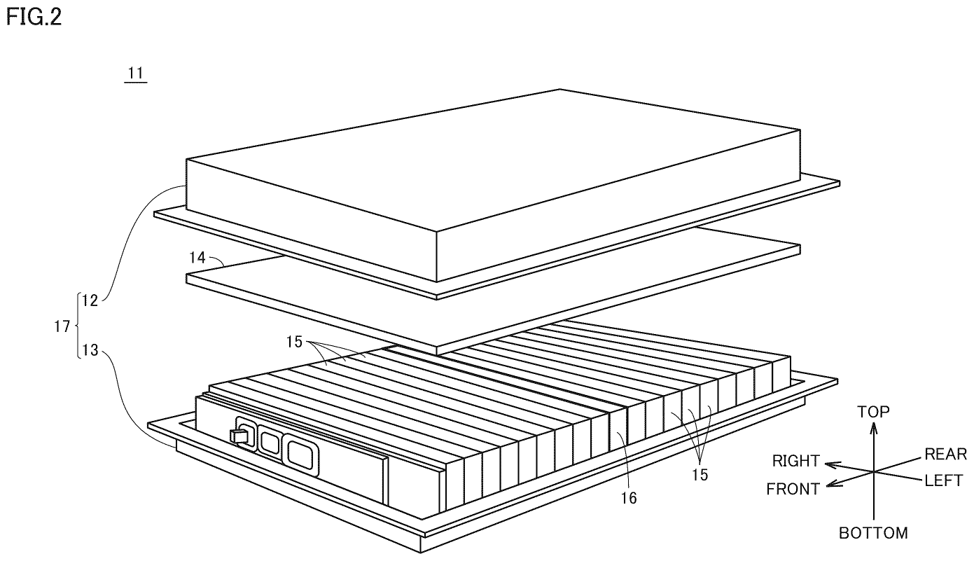

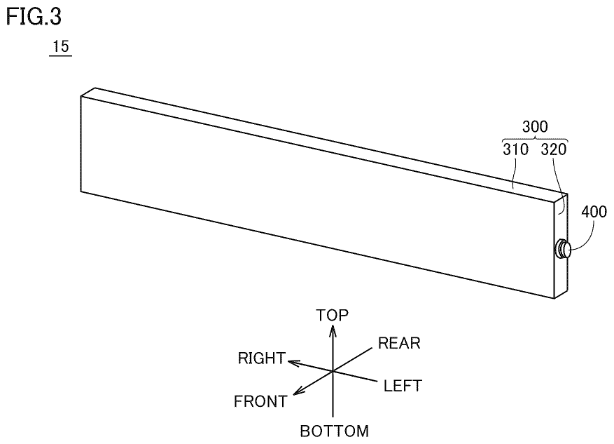

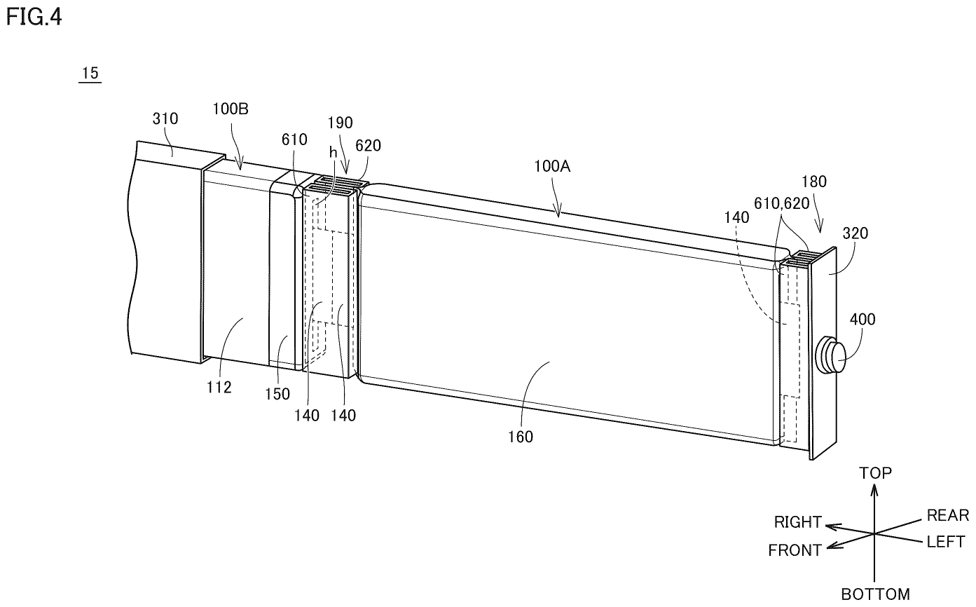

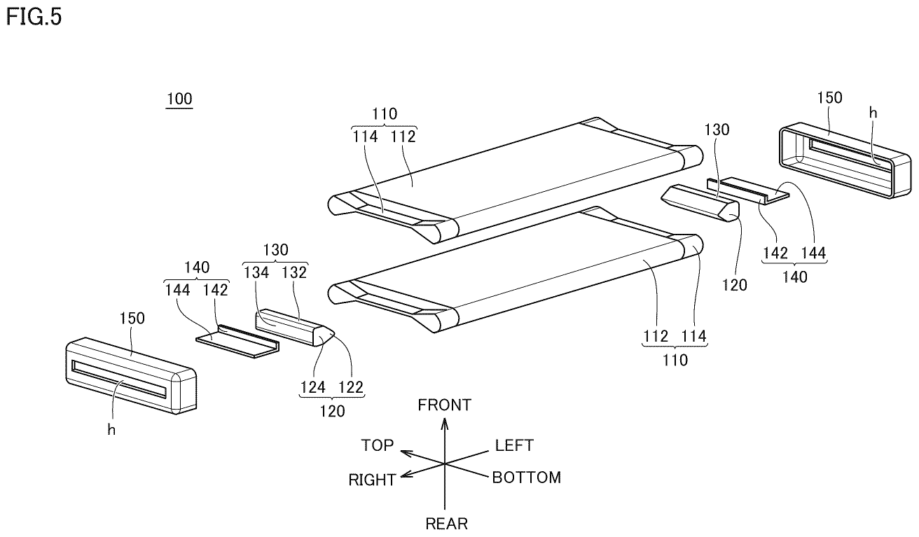

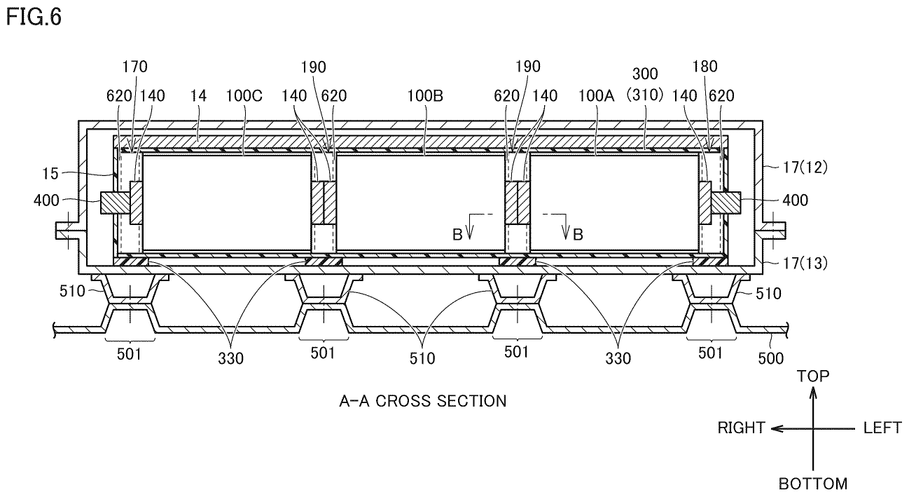

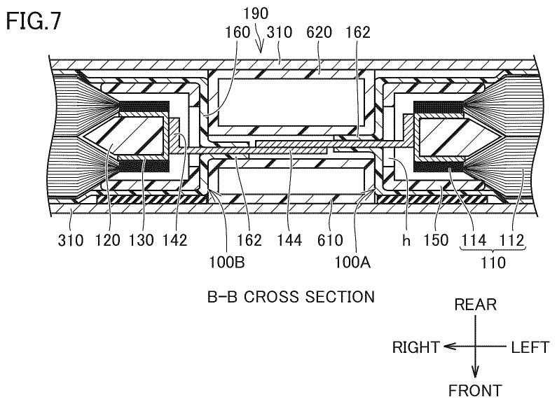

FIG. 1 is a side view showing a general shape of a vehicle 10 according to the present embodiment of the present disclosure. FIG. 2 is a perspective view showing an outlie of a configuration of a power storage device 11 mounted in vehicle 10 of the present embodiment. FIG. 3 is a perspective view showing a general shape of a power storage module 15 included in power storage device 11 of the present embodiment. FIG. 4 is an exploded perspective view of power storage module 15 of the present embodiment. FIG. 5 is an exploded perspective view of a power storage cell 100 included in power storage module 15 of the present embodiment. FIG. 6 is a sectional view of power storage device 11 of the present embodiment, which is taken along the A-A cross section. FIG. 7 is a sectional view of power storage module 15 of the present embodiment, which is taken along the B-B cross section.

Referring to FIGS. 1 to 7, the front direction, rear direction, upward direction, downward direction, right direction, and left direction are the front direction, rear direction, upward direction, downward direction, right direction, and left direction, respectively, of vehicle 10. The axes in the front-rear direction, upward-downward direction, and left-right direction are orthogonal to one another.

Vehicle 10 is an electrically-powered vehicle. The electrically-powered vehicle may be a battery electric vehicle (BEV), a plug-in hybrid electric vehicle (PHEV), a hybrid electric vehicle (HEV), or a fuel cell electric vehicle (FCEV). As shown in FIG. 1, vehicle 10 includes power storage device 11. Power storage device 11 is a device that can charge and discharge electric power for driving vehicle 10. Power storage device 11 is mounted at the bottom of the body of vehicle 10 and forms part of the floor of the vehicle cabin. However, the present disclosure is not limited thereto, and power storage device 11 may be mounted under the floor of the vehicle cabin.

As shown in FIG. 2, power storage device 11 includes an upper case 12, a lower case 13, a temperature control device 14, a plurality of power storage modules 15, and a reinforcing member 16.

Upper case 12 and lower case 13 are formed of steel material (e.g., steel plate). Upper case 12 and lower case 13 are joined together at the flanged portions thereof (e.g., fastened together with bolts and nuts at the flange portions) to be integrally formed into a power storage device case 17. A space is formed in power storage device case 17. Upper case 12 is positioned above lower case 13. Power storage device case 17 is attached to vehicle 10 such that the thickness direction thereof is aligned with the upward-downward direction of vehicle 10. The longitudinal and transverse directions of power storage device case 17, which are orthogonal to the thickness direction thereof, are aligned with the front-rear and left-right directions, respectively, of vehicle 10. Power storage device case 17 is several times longer in the longitudinal and transverse directions than in the thickness direction.

As shown in FIG. 3, power storage module 15 is a module capable of charging and discharging electric power, and has an approximately parallelepiped rectangular shape. The side of power storage module 15 in the longitudinal direction is several times longer than the side thereof in the transverse direction, which is the longer of the remaining two sides. The side of power storage module 15 in the transverse direction is several times longer than the side thereof in the thickness direction, which is the shorter of the remaining two sides. The longitudinal, transverse, and thickness directions of power storage module 15 correspond to the left-right, upward-downward, and front-rear directions, respectively, of vehicle 10.

As shown in FIG. 2, power storage module 15 is accommodated in the internal space of power storage device case 17. Power storage module 15 is accommodated such that the longitudinal, transverse, and thickness directions thereof are aligned with the transverse, thickness, and longitudinal directions, respectively, of power storage device case 17. Power storage modules 15 are accommodated so as to be stacked in the thickness direction. Reinforcing member 16 is a member that reinforces lower case 13, has an external shape that is approximately the same as that of power storage module 15, and is attached to the middle of lower case 13 in the longitudinal direction. In other words, reinforcing member 16 is provided in the middle of power storage modules 15 in the direction in which the power storage modules 15 are stacked.

Temperature control device 14 is a device that controls the temperature of power storage module 15 by heating or cooling power storage module 15. As shown in FIG. 2, temperature control device 14 is shaped into an approximately flat plate. The longitudinal and transverse directions of temperature control device 14 are shorter than the longitudinal and transverse directions of the inner surfaces of upper case 12 and lower case 13, respectively, and are aligned with these directions, respectively. Temperature control device 14 is attached to power storage modules 15 with an adhesive, for example, such that the surface thereof defined by the longitudinal direction and transverse directions of temperature control device 14 is in contact with the surface defined by the thickness and longitudinal directions of power storage modules 15. Temperature control device 14 may be attached to power storage modules 15 with an adhesive, as well as by any other method. Temperature control device 14 is accommodated in the internal space of power storage device case 17 together with power storage modules 15.

As shown in FIGS. 3 and 4, power storage module 15 includes a plurality of power storage cells 100 (power storage cells 100A, 100B in FIG. 4, power storage cells 100A to 100C in FIG. 6), a module case 300, and an external terminal 400. Module case 300 is composed of a case body 310 and a lid 320. Case body 310 and lid 320 are made of, for example, aluminum. Case body 310 has an approximately rectangular parallelepiped shape with a hollow in the longitudinal direction. Lid 320 is shaped into a rectangular flat plate that closes the opening of case body 310. The external shapes of case body 310 and lid 320 constitute part of the external shape of power storage module 15 described above. Lid 320 is joined to case body 310 by welding so as to cover the opening of case body 310. The joining method is not limited thereto, and may be another method, such as using an adhesive.

Power storage cell 100 is formed of a lithium-ion battery. However, the present disclosure is not limited thereto, and power storage cell 100 may be formed of any other type of secondary battery, such as all-solid-state battery. As shown in FIG. 4, the external shape of power storage cell 100 is an approximately rectangular parallelepiped shape. Power storage cells 100 are arranged in a single row such that the longitudinal direction of power storage cell 100 is aligned with the longitudinal direction of module case 300, and are accommodated in module case 300. Power storage cell 100 has current collector terminals 140 at the opposite ends in the longitudinal direction. Current collector terminal 140 provided at one end of power storage cell 100 in the longitudinal direction is a positive electrode terminal, and current collector terminal 140 provided at the other end is a negative electrode terminal. As adjacent power storage cells 100 are electrically connected to each other at current collector terminals 140 thereof (one is the positive electrode terminal, and the other is the negative electrode terminal), a coupling portion 190 of power storage cell 100 is formed.

As shown in FIGS. 3 and 4, external terminals 400 are provided on lids 320 at the opposite ends of power storage module 15 in the longitudinal direction. One of external terminals 400 at the opposite ends is a positive electrode terminal, and the other is a negative electrode terminal. Positive external terminal 400 is electrically connected to positive current collector terminal 140 of power storage cell 100 closest to positive external terminal 400, thereby forming a coupling portion 180. Negative external terminal 400 is electrically connected to negative current collector terminal 140 of power storage cell 100 closest to negative external terminal 400, thereby forming a coupling portion 170.

As shown in FIGS. 4, 5 and 7, power storage cell 100 includes at least one electrode body 110, an interposed member 120, a conductive film 130, current collector terminal 140, a cover 150, and a laminated outer body 160. Laminated outer body 160 is shown in power storage cell 100A in FIG. 4 and in FIG. 7, but laminated outer body 160 is not shown in power storage cell 100B in FIG. 4 and in FIG. 5.

In the present embodiment, power storage cell 100 includes two electrode bodies 110. However, the number of electrode bodies 110 included in power storage cell 100 is not limited to two. Electrode body 110 is formed of a wound body including a positive electrode sheet and a negative electrode sheet wound with a separator in between. However, electrode body 110 may be formed of a stack including the positive electrode sheet and the negative electrode sheet stacked with a separator in between. Two electrode bodies 110 are adjacent to each other in the stacking direction (the front-rear direction in FIG. 5) in which the positive electrode sheet and the negative electrode sheet are stacked on each other. Electrode body 110 is shaped to be long in the left-right direction in FIG. 5.

Electrode body 110 includes a coating portion 112 and an electrode tab 114. Coating portion 112 is a region of an electrode foil in the positive electrode sheet or the negative electrode sheet where an active material layer is provided. Electrode tab 114 is a region of the electrode foil in the positive electrode sheet or the negative electrode sheet where the active material layer is not provided, that is, an uncoated portion where the electrode foil is exposed.

Interposed member 120 is disposed between a pair of adjacent electrode tabs 114. Interposed member 120 is made of insulating material (e.g., synthetic resin). As shown in FIGS. 3 and 5, interposed member 120 includes a spacer portion 122 and a support portion 124.

Spacer portion 122 is adjacent to the boundary of a pair of adjacent coating portions 112 in the orthogonal direction and is adjacent to a pair of adjacent electrode tabs 114 in the stacking direction. Spacer portion 122 has a shape in which the dimension in the stacking direction gradually increases as it is away from the boundary of the pair of coating portions 112 in the orthogonal direction. Spacer portion 122 is shaped into an approximately triangular prism.

Support portion 124 supports each electrode tab 114. Support portion 124 protrudes outward in the orthogonal direction from spacer portion 122. Support portion 124 is formed of the same material as that of spacer portion 122 to be integral with spacer portion 122. Support portion 124 is shaped into an approximately quadrangular prism.

Conductive film 130 is made of metal (e.g., copper, aluminum). Conductive film 130 is provided on the surface of interposed member 120. Conductive film 130 is connected to each electrode tab 114. Conductive film 130 includes a pair of connection bases 132 and a coupling portion 134.

Each connection base 132 is a portion that is connected to electrode tab 114. Each connection base 132 is provided between support portion 124 and electrode tab 114. Each connection base 132 covers the outer surface of support portion 124 in the stacking direction.

Coupling portion 134 connects the pair of connection bases 132 to each other. Coupling portion 134 covers the outer surface of support portion 124 in the orthogonal direction. The thickness of coupling portion 134 may be the same as or different from the thickness of each connection base 132.

Current collector terminal 140 is connected to conductive film 130. Current collector terminal 140, which is electrically connected to positive electrode tab 114 via conductive film 130, is made of aluminum, for example. Current collector terminal 140, which is electrically connected to negative electrode tab 114 via conductive film 130, is made of copper, for example. Current collector terminal 140 includes a connection portion 142 and a protrusion 144.

Connection portion 142 is connected to coupling portion 134 by welding, but it may be connected by any other method such as soldering. Connection portion 142 is shaped into a flat plate. The thickness of connection portion 142 may be greater than the thickness of conductive film 130.

Protrusion 144 protrudes outward in the orthogonal direction from connection portion 142. Protrusion 144 is shaped into a flat plate. The thickness of protrusion 144 may be greater than the thickness of conductive film 130. As shown in FIG. 4, protrusion 144 of current collector terminal 140 in power storage cell 100A is connected to protrusion 144 of current collector terminal 140 in its adjacent power storage cell 100B.

Cover 150 covers the end of electrode body 110 in the longitudinal direction, more specifically, electrode tab 114. Cover 150 is made of insulating material (e.g., synthetic resin). As shown in FIGS. 4, 5 and 7, cover 150 has a through-hole h that causes protrusion 144 to pass therethrough.

Laminated outer body 160 accommodates two electrode bodies 110, interposed member 120, conductive film 130, part of current collector terminal 140, and cover 150. Laminated outer body 160 is formed of a laminated film. As shown in FIG. 7, laminated outer body 160 has an edge 162. Edge 162 is formed of the laminated films connected (welded) to each other. Protrusion 144 protrudes outward in the longitudinal direction of power storage cell 100 from edge 162 of laminated outer body 160.

In the case of an elongated power storage module 15 as described above, module case 300 deforms more by the action of an external force such as vibration than in the case of a power storage module that is not elongated. For this reason, it is necessary to suppress an input of an external force to power storage module 15 via power storage device case 17 from protective plate 500 (also called a “share panel”) shown in FIG. 6, which is disposed outside the bottom surface of power storage device case 17.

Thus, protective plate 500 includes a rib 501 connected to power storage device case 17. Rib 501 is higher in at least one of rigidity and strength than the portion of protective plate 500 which is located around rib 501. The high-rigidity portion is a portion that deforms less easily upon application of a force. The high-strength portion is a portion that breaks less easily upon application of a force.

As a result, rib 501 of protective plate 500 is connected to power storage device case 17 that accommodates power storage modules 15, the rib 501 being higher in at least one of rigidity and strength than the portion of protective plate 500 which is located around rib 501. This can suppress an input of an external force, applied to protective plate 500, to power storage device case 17 that accommodates power storage modules 15 more than when the portion of protective plate 500 which is located around rib 501 is connected to power storage device case 17. As a result, an input of an external force from protective plate 500 to power storage modules 15 can be suppressed.

As shown in FIGS. 4, 6 and 7, partition members 610, 620 are provided at coupling portions 170, 180, 190 of power storage cell 100 so as to sandwich the connection portions of current collector terminals 140 on the opposite sides or the connection portions between current collector terminal 140 and external terminal 400. Partition members 610, 620 are quadrangular prisms that are hollow in the upward-downward direction, which is the longitudinal direction. Partition members 610, 620 may be made of synthetic resin or metal. Case body 310 of module case 300 is composed of a top plate and a bottom plate that are orthogonal to each other in the upward-downward direction, and two side plates that are orthogonal to each other in the front-rear direction. The longitudinal lengths of partition members 610, 620 are the same as the widths of the inner surfaces of the top plate and the bottom plate of case body 310. As a result, partition members 610, 620 function as reinforcing members (so-called support rods) between the top plate and the bottom plate of coupling portions 170, 180, 190 of case body 310.

The outer surface of case body 310 of module case 300 below coupling portions 170, 180, 190 and the inner surface of lower case 13 of power storage device case 17 are joined together with the adhesive of an adhesive joining portion 330. As a result, power storage module 15 is fixed to power storage device case 17 with the adhesive below coupling portions 170, 180, 190.

Power storage device 11 further includes a reinforcement 510. Reinforcement 510 is provided below coupling portions 170, 180, 190. Reinforcement 510 is formed of steel material (e.g., steel plate). Reinforcement 510 is joined to lower case 13 of power storage device case 17 by welding. Reinforcement 510 is provided across the width of lower case 13 in the longitudinal direction.

Power storage device 11 further includes a protective plate 500. Protective plate 500 is provided below lower case 13 of power storage device case 17. Protective plate 500 is formed of steel material (e.g., steel plate). Rib 501 is provided below coupling portions 170, 180, 190 in protective plate 500 across the width of lower case 13 in the longitudinal direction. The rib 501 portion of protective plate 500 is configured to be higher in rigidity and strength than the portion located around rib 501. Rib 501 is used as a connection portion to reinforcement 510. Rib 501 and reinforcement 510 are fastened together at the connection portion with bolts and nuts. However, the present disclosure is not limited thereto, and rib 501 and reinforcement 510 may be joined by any other method, such as welding or bonding.
(1) In the embodiment described above, as shown in FIG. 6, module case 300 of power storage module 15 includes three power storage cells 100. However, the number of power storage cells 100 included in module case 300 is not limited thereto, and may be two or may be four or more.
(2) In the embodiment described above, as shown in FIG. 6, power storage device case 17 includes reinforcement 510 as a fixing portion connected to the connection portion of protective plate 500. However, the present disclosure is not limited thereto, and the fixing portion may be provided in power storage device case 17 itself. In other words, power storage device case 17 and protective plate 500 may be joined together without using reinforcement 510 in between.
(3) In the embodiment described above, as shown in FIG. 6, the connection portion of protective plate 500 which is connected to power storage device case 17 is formed of rib 501. However, the present disclosure is not limited thereto, and such a connection portion may have a structure different from that of rib 501, as long as the connection portion is higher in at least one of rigidity and strength than the portion of protective plate 500 which is located around the connection portion, for example, a structure in which a reinforcing member is welded to protective plate 500.

### Concluding Description

(1) As shown in FIGS. 1, 2 and 6, power storage device 11 includes power storage modules 15 that can charge and discharge electric power, power storage device case 17 that accommodates power storage modules 15, and protective plate 500 disposed outside the bottom surface of power storage device case 17. As shown in FIG. 6, protective plate 500 includes a connection portion (e.g., rib 501) connected to power storage device case 17. The connection portion is higher in at least one of rigidity and strength than a portion of protective plate 500 which is located around the connection portion.

Thus, the connection portion of protective plate 500, which is higher in at least one of rigidity and strength than the portion of protective plate 500 which is located around the connection portion, is connected to power storage device case 17 that accommodates power storage modules 15. This can suppress an input of an external force, applied to protective plate 500, to power storage device case 17 that accommodates power storage modules 15 more than when the portion of protective plate 500 which is located around the connection portion is connected to power storage device case 17. As a result, the input of an external force from protective plate 500 to power storage modules 15 can be suppressed.
(2) As shown in FIG. 6, power storage device case 17 may include a fixing portion (e.g., reinforcement 510) connected to the connection portion of protective plate 500. Each of power storage modules 15 may be fixed to the portion of the inner surface of power storage device case 17 which is located above the fixing portion.

Thus, the fixing portion of power storage device case 17 is connected to the connection portion of protective plate 500 which is higher in at least one of rigidity and strength than the portion of protective plate 500 which is located around the connection portion. This can suppress an input of an external force, applied to protective plate 500, to the fixing portion of power storage device case 17 that accommodates power storage modules 15 more than when power storage device case 17 is connected to the portion of protective plate 500 which is located around the connection portion. As a result, the input of an external force from protective plate 500 to power storage modules 15 can be suppressed.
(3) As shown in FIG. 6, the power storage device may further include an adhesive of adhesive joining portion 330 which bonds each of power storage modules 15 to power storage device case 17. The adhesive may be provided at the portion of the inner surface of power storage device case 17 which is located above the fixing portion.

Thus, power storage module 15 is bonded to the portion located above the fixing portion with the adhesive. As a result, power storage module 15 can be more firmly fixed to the robust portion of power storage device case 17 than when power storage module 15 is bonded to the portion of power storage device case 17 which is different from the portion located above the fixing portion.
(4) As shown in FIGS. 3 to 7, each of power storage modules 15 may include power storage cells 100 including a first power storage cell (e.g., power storage cell 100A) and a second power storage cell (e.g., power storage cell 100B) arranged in one direction, and coupling portion 170, 180, 190, and module case 300 that accommodates power storage cells 100 and coupling portion 170, 180, 190. The first power storage cell may include a first end (e.g., cover 150) adjacent to the second power storage cell and a first terminal (e.g., current collector terminal 140) provided at the first end. The second power storage cell may include a second end (e.g., cover 150) adjacent to the first power storage cell and a second terminal (e.g., current collector terminal 140) provided at the second end. Coupling portion 170, 180, 190 may be formed by connection of the first terminal and the second terminal. Each of power storage modules 15 may be fixed to power storage device case 17 in the portion of the outer surface of module case 300 which is located outside of coupling portion 170, 180, 190.

Thus, power storage module 15 is fixed to power storage device case 17 in the portion of the outer surface of module case 300 of power storage module 15 which is located outside coupling portion 170, 180, 190 at which the first terminal of the first power storage cell is connected to the second terminal of the second power storage cell. As a result, coupling portion 170, 180, 190 can be effectively fixed to power storage device case 17.
(5) As shown in FIGS. 4, 6, and 7, module case 300 may include a top plate and a bottom plate arranged in the upward-downward direction. Each of power storage modules 15 may include partition member 610, 620 provided in module case 300 and provided in coupling portion 170, 180, 190. Partition member 610, 620 may be disposed across the top plate and bottom plate.

Thus, coupling portion 170, 180, 190 of each of power storage modules 15 which is fixed to power storage device case 17 can be made robust due to partition member 610, 620.
(6) As shown in FIG. 6, protective plate 500 may include a main body shaped into a plate and rib 501 formed to protrude upward from the main body. The connection portion may be rib 501.

Thus, the connection portion of protective plate 500 which is connected to power storage device case 17 can be made robust. Also, protective plate 500 itself can be made robust.

Although the present embodiments of the present disclosure have been described, it should be understood that the present embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a plurality of power storage modules that charge and discharge electric power;
an accommodation case that accommodates the plurality of power storage modules; and
a protective plate disposed outside a lower surface of the accommodation case, wherein
the protective plate includes a connection portion connected to the accommodation case, and
the connection portion is higher in at least one of rigidity and strength than a portion of the protective plate, the portion being located around the connection portion.

2. The power storage device according to claim 1, wherein
the accommodation case includes a fixing portion connected to the connection portion of the protective plate, and
each of the plurality of power storage modules is fixed to a portion of an inner surface of the accommodation case, the portion being located above the fixing portion.

3. The power storage device according to claim 2, further comprising an adhesive that bonds each of the plurality of power storage modules to the accommodation case,
wherein the adhesive is provided at a portion of the inner surface of the accommodation case, the portion being located above the fixing portion.

4. The power storage device according to claim 2, wherein
each of the plurality of power storage modules includes
a plurality of power storage cells including a first power storage cell and a second power storage cell arranged in one direction,
a coupling portion, and
a module case that accommodates the plurality of power storage cells and the coupling portion,
the first power storage cell includes
a first end adjacent to the second power storage cell, and
a first terminal provided at the first end,
the second power storage cell includes
a second end adjacent to the first power storage cell, and
a second terminal provided at the second end,
the coupling portion is formed by connection of the first terminal and the second terminal, and
each of the plurality of power storage modules is fixed to the accommodation case in a portion of an outer surface of the module case, the portion being located outside the coupling portion.

5. The power storage device according to claim 4, wherein
the module case includes a top plate and a bottom plate arranged in an upward-downward direction,
each of the plurality of power storage modules includes a partition member provided in the module case and provided at the coupling portion, and
the partition member is disposed across the top plate and the bottom plate.

6. The power storage device according to claim 1, wherein
the protective plate incudes
a body portion shaped into a plate, and
a rib formed to protrude upward from the body portion, and
the connection portion is the rib.
